(19) United States
(12) Patent Application Publication
(10) Pub. No.: US 2019/0087732 A1
(43) Pub. Date: Mar. 21, 2019

(54) ONTOLOGY-BASED REASONING APPARATUS, SYSTEM AND METHOD USING USER-DEFINED RULES

(71) Applicant: FOUNDATION OF SOONGSIL UNIVERSITY INDUSTRY COOPERATION, Seoul (KR)

(72) Inventors: Young Tack PARK, Seoul (KR); Wan Gon LEE, Seoul (KR); Sung Hyuk BANG, Seoul (KR)

(21) Appl. No.: 15/852,576

(22) Filed: Dec. 22, 2017

(30) Foreign Application Priority Data
Sep. 19, 2017 (KR) 10-2017-0120332

(51) Int. Cl. G06N 5/02; G06F 17/27; G06F 17/30

(52) U.S. Cl. CPC G06N 5/025; G06F 17/30722; G06F 17/2785; G06F 17/272

(57) ABSTRACT

Disclosed are ontology-based reasoning apparatus, system, and method using user-defined rules. The ontology-based reasoning apparatus includes a memory storing two or more triple data; and a processor connected to the memory, in which the processor parses user-defined rules input from a user in ontology-based rules to generate a plurality of condition meta information corresponding to a plurality of conditions included in a condition section of the user-defined rules and one result meta information corresponding to one result included in a conclusion section of the user-defined rules, retrieves a plurality of triple data in two or more triple data prestored using the plurality of condition meta information, and reasons new triple data from the plurality of triple data retrieved using the result meta information to store the reasoned new triple data in the memory.

### CROSS-REFERENCE TO RELATED APPLICATION

This application claims under 35 U.S.C. § 119(a) the benefit of Korean Patent Application No. 10-2017-0120332 filed on Sep. 19, 2017, the entire contents of which are incorporated herein by reference.

### BACKGROUND

### (a) Technical Field

Exemplary embodiments of the present invention relate to ontology-based reasoning apparatus, system, and method using user-defined rules capable of minimizing network shuffling occurring in a distributed reasoning process and reducing a required time for reasoning by performing reasoning using user-defined rules.

The present invention is the patent filled as a part of SW computing commercial source technology development project and related details are as follows.

Subdivision: Ministry of Science, ICT and Future Planning

Specialized Institute: Information and Communication Technology Research and Promotion Center

Research Project Title: WiseKB: Development of self-learning knowledge base and reasoning technology based on big data understanding

Research Institute (Managing Department): Saltlux Corporation

Research Institute (Consignment Department) : Soongsil University Research & Business Foundation, Kyungpook National University Research & Business Foundation, Seoul National University Research & Business Foundation, Seoul City University Research & Business Foundation, Korea Advanced Institute of Science and Technology, KT Corporation, Cloudine Corporation, and Synapsoft Corporation

Project No. R0101-15-0054

### (b) Background Art

Semantic web as a term used for the next generation web is the official name used in the World Wide Web Consortium (W3C), the web international organization for standardization. The current web is a simple link, but in the semantic web, a machine can read, understand, and process data on the Web using artificial intelligence.

In order to implement the semantic web, ontology is used. The ontology means the formal and explicit specification for the shared conceptualization and is a core concept for implementing the semantic web. In the ontology, a relationship between concepts is defined.

The ontology may extend knowledge by generating new information from given data through reasoning, thereby increasing the range of knowledge services provided to users. The reasoning of ontology for knowledge extension is divided into Axiom reasoning using rules of functions such as RDFS or OWL and rule based reasoning using rules generated based on user's empirical knowledge.

The Axiom reasoning generates new data through a relationship between schemas or a relationship between a schema and an instance containing actual information. In this case, since the number of reasoning rules is limited, the reasoning is performed according to a predefined order. On the other hand, since the rule based reasoning uses user-defined rules, the kinds and number of reasoning rules is more than those of the Axiom reasoning and it is difficult to determine the order of execution between the reasoning rules.

However, the reasoning rules written based on the semantic web rule language (SWRL) can use various embedded functions as well as user-defined rules to support higher expressions.

Meanwhile, FIG. 1 is a diagram for describing a concept of a reasoning engine of horn-like rules in the related art.

Referring to FIG. 1, the reasoning engine of the horn-like rules operates based on Hadoop, and the SWRL reasoning is possible using a user-defined rule in a distributed processing framework.

In this case, the reasoning engine of the horn-like rules makes a small group of conditions of each rule to a small group and avoids unnecessary work by reusing the conditions redundantly used in multiple rules.

However, since a lot of network shuffling occurs between nodes in the distributed processing, there is a problem in that the performance is degraded. Also, due to the limitations of map-reduce that require intermediate results to be prepared to a file, there is also a problem in that the performance of reasoning operations that require repetitive operations is degraded.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art and to provide ontology-based reasoning apparatus, system, and method using user-defined rules capable of minimizing network shuffling occurring in a distributed reasoning process and reducing a required time for reasoning by performing reasoning using user-defined rules.

Other objects of the present invention will be drawn by those skilled in the art through the following exemplary embodiments.

According to an exemplary embodiment of the present invention, there is provided an ontology-based reasoning apparatus including: a memory storing two or more triple data; and a processor connected to the memory, in which the processor parses user-defined rules input from a user in ontology-based rules to generate a plurality of condition meta information corresponding to a plurality of conditions included in a condition section of the user-defined rules and one result meta information corresponding to one result included in a conclusion section of the user-defined rules, retrieves a plurality of triple data in two or more triple data prestored using the plurality of condition meta information, and reasons new triple data from the plurality of triple data retrieved using the result meta information to store the reasoned new triple data in the memory.

The condition may be one of a general condition and a comparison condition, the general condition and the comparison condition may include at least one variable, the comparison condition may include a comparison function for limitation of the variable, and the condition meta information may include subject (S) information, predicate (P) information, and object (O) information.

Each of the general condition and the comparison condition may include a first component, a second component, and a third component, the first component of the general condition may correspond to the subject information of the condition meta information, the second component of the general condition may correspond to the predicate information of the condition meta information, and the third component of the general condition may correspond to the object information of the condition meta information, the first component of the comparison condition may correspond to the subject information of the result meta information, the second component of the comparison condition may correspond to a comparison function, and the third component of the comparison condition may correspond to a limited value of the first component of the comparison condition, and at least one of the first component and the third component of the general condition may constitute a variable and the first component of the comparison condition may constitute a variable.

When the conditional section includes both the general condition and the comparison condition, the processor may retrieve a general condition including the same variable as one variable included in the comparison condition among the general conditions included in the condition section and generate one condition meta information A by merging the comparison condition and the retrieved general condition.

The subject information of the condition meta information A may be a first component of the retrieved general condition, the predicate information of the condition meta information A may be a second component of the retrieved general condition, and the object information of the condition meta information A may be a value that limits the third component of the comparison condition to the second component of the comparison condition.

The processor may generate one condition meta information B from one general condition which is not merged with the comparison condition, and subject information of the condition meta information B may be the first component of the general condition, predicate information of the condition meta information B may be the second component of the general condition, and object information of the condition meta information B may be the third component of the general condition.

The result meta information may include subject information, predicate information, and object information, the result may include a first component, a second component, and a third component, and the subject information of the result meta information may be the first component of the result, the predicate information of the result meta information may be the second component of the result, and the object information of the result meta information may be the third component of the result.

The memory may store the two or more triple data in a form of table A, a column of the table A may be a predicate of the two or more triple data, a row of the table A may be a subject of the two or more triple data, and a value of the table A may be an object of the two or more triple data or a null value, and the processor may retrieve the plurality of triple data corresponding to the plurality of condition meta information based on the predicates of the two or more triple data.

The processor may perform incremental reasoning that reasons the result by setting the new triple data and at least one of the two or more triple data as conditions when the new triple data is reasoned as a result.

The processor may perform the incremental reasoning based on a table B that indicates two or more ontology-based rules and a relationship between the two or more ontology-based rules, the result of any one ontology-based rule of the two or more ontology-based rules may be set as a condition of another ontology-based rule of the two or more ontology-based rules, the table B may include two columns, and in each row included in a column A of the two columns, each of the two or more ontology-based rules may be set to a value, and in each row included in a column B of the two columns, each of the ontology-based rules affected by the value of the column A may be set as a value.

According to another exemplary embodiment of the present invention, there is provided an ontology-based reasoning system including: a plurality of ontology-based reasoning apparatuses including memories and processors, in which each of the plurality of ontology-based reasoning apparatuses may parse user-defined rules input from a user in ontology-based rules to generate a plurality of condition meta information corresponding to a plurality of conditions included in a condition section of the user-defined rules and one result meta information corresponding to one result included in a conclusion section of the user-defined rules, retrieve a plurality of triple data in two or more triple data prestored using the plurality of condition meta information, and reason new triple data from the plurality of triple data retrieved using the result meta information to store the reasoned new triple data in the memory, and when the reasoning of the new triple data is completed in any one ontology-based reasoning apparatus among the plurality of ontology-based reasoning apparatuses, the any one ontology-based reasoning apparatus may transmit the reasoned new triple data to the remaining ontology-based reasoning apparatuses except for the any one ontology-based reasoning apparatus among the plurality of ontology-based reasoning apparatuses.

According to yet another exemplary embodiment of the present invention, there is provided an ontology-based reasoning method which is performed by an apparatus including a processor including: parsing user-defined rules which are rules newly defined by a user in ontology-based rules constituted by a condition section and a conclusion section to generate a plurality of condition meta information corresponding to a plurality of conditions included in the condition section and one result meta information corresponding to one result included in the conclusion section; retrieving a plurality of triple data in two or more triple data prestored using the plurality of condition meta information; and reasoning new triple data from the plurality of triple data retrieved using the result meta information.

According to the present invention, it is possible to minimize network shuffling occurring in distributed reasoning processing and reduce a required time for reasoning.

Further, the effects of the present invention are not limited to the above effects and it should be understood that the effects include all effects reasonable from the configurations of the invention disclosed in the detailed description or claims of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram for describing a concept of a reasoning engine of horn-like rules in the related art;

FIG. 2 is a diagram illustrating a schematic configuration of an ontology-based reasoning system according to an exemplary embodiment of the present invention;

FIG. 3 is a diagram for describing a concept of a distributed reasoning method using a user-defined rule according to the exemplary embodiment of the present invention;

FIG. 4 is a diagram illustrating a flowchart of an ontology-based reasoning method according to an exemplary embodiment of the present invention;

FIG. 5 is a diagram illustrating an example of parsing of a SWRL-based user-defined rule according to an exemplary embodiment of the present invention;

FIG. 6 is a diagram illustrating another example of parsing of a SWRL-based user-defined rule according to an exemplary embodiment of the present invention;

FIG. 7 is a diagram for describing an example of addition of information depending on generation of new triple data according to the exemplary embodiment of the present invention;

FIG. 8 is a diagram for describing a concept for distributed reasoning according to the exemplary embodiment of the present invention; and

FIGS. 9 and 10 are diagrams for describing a concept of incremental reasoning according to the exemplary embodiment of the present invention.

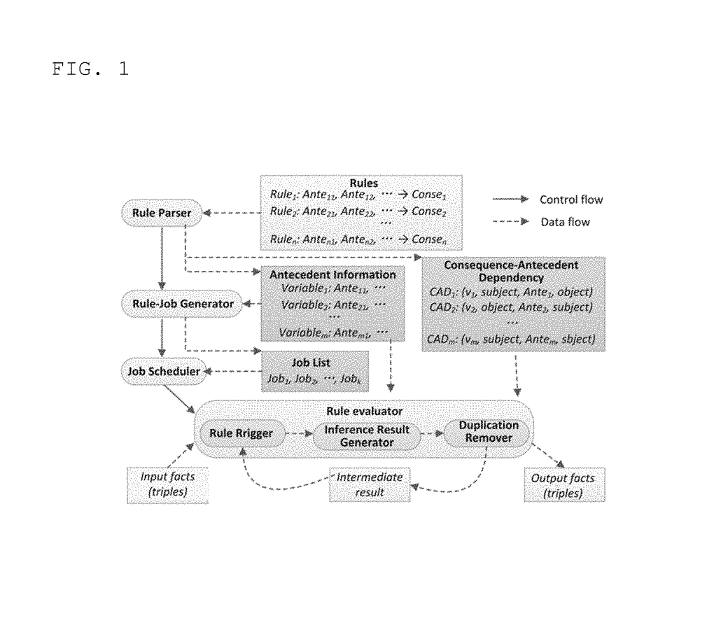

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, reference will now be made in detail to various embodiments of the present disclosure, examples of which are illustrated in the accompanying drawings and described below.

Singular expressions used in the present specification include plural expressions unless they have definitely opposite meanings in the context. In the present specification, the term of “comprising” or “including” should not be interpreted as necessarily including all various components or various steps disclosed in the invention, and it should be interpreted that some component or some steps among them may not be included or additional components or steps may be further included. In addition, the terms of “-er” and “module” described in the specification mean units for processing at least one function and operation and can be implemented by hardware components or software components and combinations thereof.

Hereinafter, various exemplary embodiments of the present invention will be described in detail with reference to the accompanying drawings.

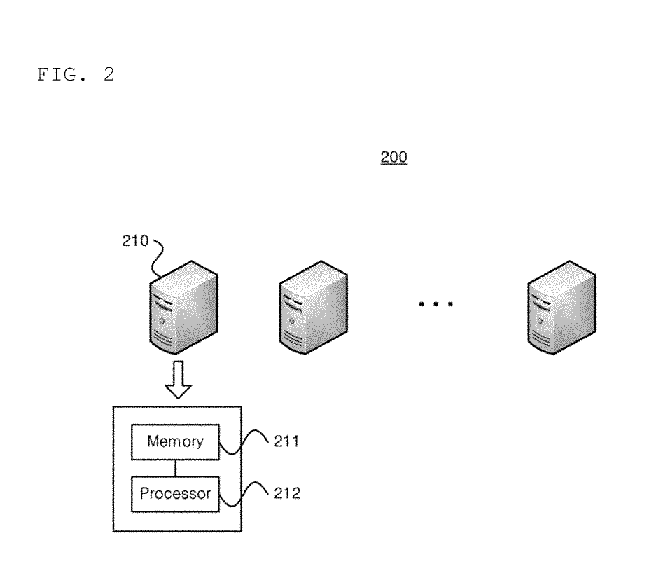

FIG. 2 is a diagram illustrating a schematic configuration of an ontology-based reasoning system according to an exemplary embodiment of the present invention.

Referring to FIG. 2, an ontology-based reasoning system 200 according to an exemplary embodiment of the present invention includes a plurality of ontology-based reasoning apparatus 210.

Each of the plurality of ontology-based reasoning apparatus 210 performs ontology-based reasoning using ontology-based rules. That is, the plurality of ontology-based reasoning apparatus 210 performs the ontology-based reasoning. In this case, each of the plurality of ontology-based reasoning apparatus 210 according to the present invention performs the reasoning using user-defined rules, rules newly defined by the user as well as predefined rules.

As an example, the ontology-based rules may be semantic web rule language (SWRL) rules.

The SWRL is a rule language developed to reason user's empirical knowledge that can not be derived from Axiom-based rules and a rule expression language that integrates OWL-LITE which is a sublanguage of the ontology web language (OWL), and OWL-DL, Unary/BinaryDatalog RuleML which is a sublanguage of the rule makeup language RuleML. Like most rules, the SWRL may be defined as a structure of a pair of condition and result, and when the SWRL is expressed in the language provided by the SWRL rule, the condition is expressed as ‘Body’ and the result is expressed as ‘Head’. The Body and the Head may have one or more atoms to use the logical product (And) of atoms.

On the other hand, each of the plurality of ontology-based reasoning apparatus 210 includes a memory 211 and a processor 212 to perform the ontology-based reasoning.

The memory 211 may be a volatile and/or nonvolatile memory and may stores commands or data related to at least one of other components of the ontology-based reasoning apparatus 210. In particular, the memory 211 stores two or more triple data, which is a large amount of data.

In this case, the triple data is constituted by a subject S, a predicate P and an object O, and the memory 211 may store two or more triple data on the basis of the predicate. The detailed contents thereof will be described below.

The processor 212 includes one or more of a central processing unit, an application processor, or a communications processor and is connected to the memory 211. For example, the processor 212 may perform operations and data processing on the control and/or communication of at least one of other components of the ontology-based reasoning apparatus 210. In particular, the processor 212 performs the reasoning using user-defined rules input from the user and two or more triple data stored in the memory 211.

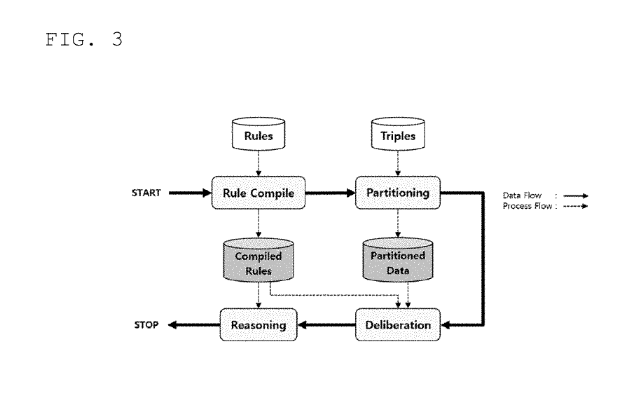

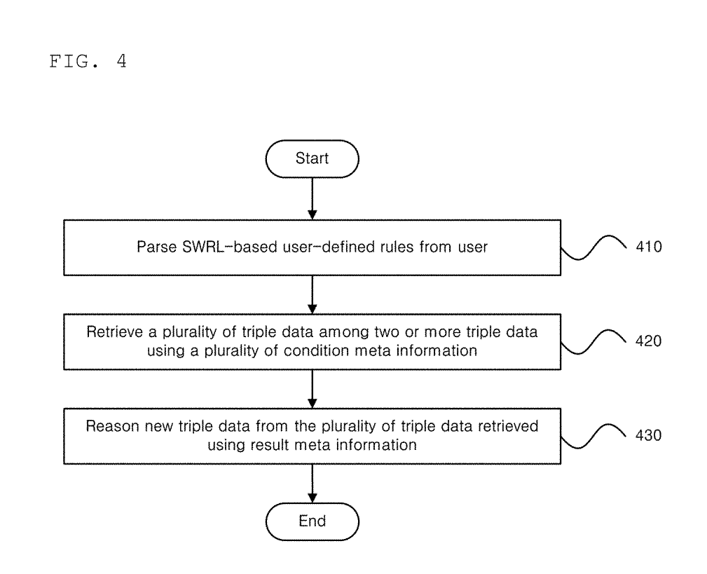

Hereinafter, an ontology-based reasoning method performed based on the processor 212 will be described in more detail with reference to FIGS. 3 and 4.

FIG. 3 is a diagram for describing a concept of a distributed reasoning method using user-defined rules according to the exemplary embodiment of the present invention and FIG. 4 is a diagram illustrating a flowchart of an ontology-based reasoning method according to an exemplary embodiment of the present invention. In this case, the contents described in FIGS. 3 and 4 may be applied to each of the plurality of ontology-based reasoning apparatuses 210. Hereinafter, a process of performing each step will be described with reference to FIG. 4.

First, in step 410, the processor 212 analyzes and parses the SWRL-based user-defined rules from the user. Accordingly, the processor 212 generates condition meta information and result meta information.

More specifically, as described above, the SWRL-based user-defined rules are configured by a condition section including a plurality of conditions and a conclusion section including one result. The plurality of conditions are connected to each other through the logical product And.

Table 1 illustrates an example of the SWRL-based user-defined rules.

TABLE 1

| # | Conditions | Conclusion |
|---|---|---|
| 1 | xbp:education(?a, ?c) \hat{ }^xbp:education(?b, ?c) | xbp:alumni(?a, ?b) |
| 2 | xbp:parent(?b, ?f) \hat{ }^xbp:spouse(?a, ?f) | xbp:child(?a, ?b) |
| 3 | xbp:diedIn(?a, ?b) \hat{ }^xbp:bornIn(?a, ?b) | xbp:livedIn(?a, ?b) |
| 4 | xbp:link(?a, ?f) \hat{ }^xbp:link(?b, ?f) | xbp:link(?a, ?b) |
| 5 | xbp:father(?e, ?a) \hat{ }^xbp:surname(?e, ?b) | xbp:surname(?a, ?b) |
| 6 | xbp:brother(?a, ?f) \hat{ }^xbp:relative(?f, ?b) | xbp:relative(?a, ?b) |
| 7 | xbp:sister(?f, ?a) \hat{ }^xbp:sister(?b, ?f) | xbp:sister(?a, ?b) |
| 8 | xbp:child(?a, ?f) \hat{ }^xbp:child(?b, ?f) | xbp:spouse(?a, ?b) |
| 9 | xbp:capital(?e, ?a) \hat{ }^xbp:language(?e, ?b) | xbp:language(?a, ?b) |
| 10 | xbp:creation(?a, ?b) \hat{ }^xbc:show(?b) | xbp:director(?b, ?a) |
| 11 | xbp:creation(?a, ?b) \hat{ }^xbc:artifact(?b) | xbp:producer(?b, ?a) |
| 12 | xbp:creation(?a, ?b) \hat{ }^xbc:painting(?b) | xbp:painter(?b, ?a) |
| 13 | xbp:child(?f, ?b) \hat{ }^xbp:spouse(?a, ?f) | xbp:child(?a, ?b) |
| 14 | xbp:child(?a, ?f) \hat{ }^xbp:child(?b, ?f) | xbp:spouse(?a, ?b) |
| 15 | xbp:sp_withIn(?f, ?b) \hat{ }^xbp:livedIn(?a, ?f) | xbp:livedIn(?a, ?b) |
| 16 | xbp:mother(?f, ?b) \hat{ }^xbp:mother(?a, ?f) | xbp:grandmother(?a, ?b) |
| 17 | xbp:relative(?f, ?a) \hat{ }^xbp:sister(?b, ?f) | xbp:relative(?a, ?b) |
| 18 | xbp:child(?f, ?a) \hat{ }^xbp:mother(?b, ?f) | xbp:sibling(?a, ?b) |
| 19 | xbp:anthem(?f, ?b) \hat{ }^xbp:nationality(?a, ?f) | xbp:anthem(?a, ?b) |
| 20 | xbp:child(?a, ?f) \hat{ }^xbp:child(?b, ?f) | xbp:spouse(?a, ?b) |

In this case, the condition included in the conditional section may be one of a general condition or a comparison condition and includes a first component, a second component and a third component. In the case of the general condition, the first component may correspond to a subject S of the triple data, the second component may correspond to a predicate P of the triple data, and the third component may correspond to an object O of the triple data. Herein, at least one of the first component and the third component constitutes a variable. In the case of the comparison condition, the first component is a variable, the second component corresponds to a comparison function, and the third component may correspond to a limit value of the first component of the comparison condition.

In addition, the result included in the result section may also include a first component, a second component, and a third component. The first component of the result may correspond to a subject S of the triple data, the second component may correspond to a predicate P of the triple data, and the third component may correspond to an object O of the triple data.

Meanwhile, each of the condition meta information and the result meta information is information obtained by converting human-recognizable SWRL-based user-defined rules into a machine-recognizable form. In this case, the processor 212 may generate at least one condition meta information in a plurality of conditions and generate one result meta information from one result by parsing the SWRL-based user-defined rules. In this case, the condition meta information and the result meta information may include subject information, predicate information, and object information.

According to the exemplary embodiment of the present invention, when the condition section includes both the general conditions and the comparison conditions, the processor 212 may retrieve a general condition including the same variable as one variable included in the comparison condition in the general conditions included in the condition section and generate one condition meta information by merging the comparison condition and the retrieved general condition. In this case, the merging of the comparison condition and the retrieved general condition may be first performed, thereby reducing a retrieve amount of triple data for reasoning. For convenience, the type of condition meta information generated by merging is referred to as condition meta information A.

Herein, the subject information of the condition meta information A is a first component of the retrieved general condition, the predicate information of the condition meta information A is a second component of the retrieved general condition, and the object information of the condition meta information A may be a value that limits the third component of the comparison condition to the second component of the comparison condition.

In addition, according to the exemplary embodiment of the present invention, when the conditional section includes only the general condition or the conditional meta information depending on the comparison condition is first generated, the processor 212 may generate condition meta information from one general condition that is not merged with the comparison condition. In this case, the order of the condition meta information may be determined depending on the number of variables included in the general condition, thereby reducing the retrieve amount of triple data for reasoning. For convenience, the type of non-merged condition meta information is referred to as condition meta information B.

Herein, the subject information of the condition meta information B may be a first component of the general condition, the predicate information of the condition meta information B may be a second component of the general condition, and the object information of the condition meta information B may be a third component of the general condition.

Further, according to the exemplary embodiment of the present invention, the subject information of the result meta information is a first component of the result, the predicate information of the result meta information is a second component of the result, and the object information of the result metal information is a third component of the result.

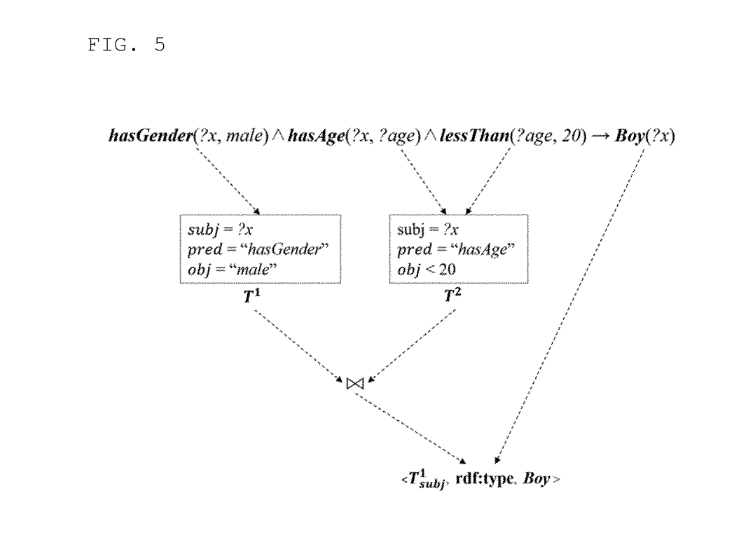

Hereinafter, the parsing of SWRL-based user-defined rules according to the exemplary embodiment of the present invention will be described in more detail with reference to FIG. 5.

FIG. 5 is a diagram illustrating an example of parsing of SWRL-based user-defined rules according to an exemplary embodiment of the present invention.

Referring to FIG. 5, the SWRL-based user-defined rule means “if the gender is male and the age is 20 years or younger, a person is a boy”. In this case, three conditions are included in the condition section, and two conditions are general conditions, and one condition is a comparison condition.

Specifically, a condition hasGender (?x, male) has the same meaning as (?x, hasGender, male) as a general condition, and a first component is ‘x’, a second component is ‘hasGender’, a third component is ‘male’ and ‘?x’ is a variable. A condition hasAge(?x, ?age) has the same meaning as (?x, hasAge, ?age) as a general condition, and a first component is ‘?x’, a second component is ‘hasAge’, a third component is ‘?age’ and ‘?x’ and ‘?age’ are variables. A condition lessThan(?age, 20) is a comparison condition, a first component is ‘?age’, a second component is ‘lessThan’ which is a comparison function, a third component is ‘20’, and ‘?age’ is a variable. In addition, the result Boy(?x) has the same meaning as (?x,rdf:type, boy), and a first component is ‘?x’, a second component is ‘type’, a third component is ‘boy’ and ‘?x’ is a variable.

Meanwhile, since the comparison condition is present in the condition section, the processor 212 first retrieves a general condition to be merged with the comparison condition and generates the condition meta information T2 based on the comparison condition and the retrieved general condition. That is, the processor 212 retrieves a general condition hasAge(?x, ?age) having the same variable as the variable ‘?age’ of the comparison condition and generates the condition meta information T2 based on the retrieved general condition. At this time, the type of condition meta information T2 is the condition meta information A, and the subject information of the condition meta information T2 is ‘?x’ which is the first component of the retrieved general condition hasAge(?x, ?age), the predicate information of the condition meta information T2 is ‘hasAge’ which is the second component of the retrieved general condition hasAge(?x, ?age), and the object information of the condition meta information T2 is ‘<20’ which is a value obtained by limiting ‘20’ which is the third component of the comparison condition lessThan(?age, 20) to ‘lessThan’ which is the second component.

After the condition meta information T2 is generated, the processor 212 generates the condition meta information T1 corresponding to the remaining general condition hasGender(?x, male). That is, the type of condition meta information T1 is the condition meta information B, and the subject information of the condition meta information T1 is ‘?x’ which is the first component of the general condition hasGender(?x, male), the predicate information of the condition meta information T1 is ‘hasGender’ which is the second component of the general condition hasGender(?x, male), and the object information of the condition meta information T1 is ‘male’ which is the third component of the general condition hasGender(?x, male).

Thereafter, the processor 212 generates the result meta information corresponding to the result. At this time, the processor 212 may generate result meta information with reference to the condition meta information. That is, the processor 212 sets the first component ‘?x’ of the result as the subject information of the result meta information, sets the second component ‘ref:tpye’ of the result as the predicate information of the result meta information, and sets the third component ‘boy’ of the result as the object information of the result meta information.

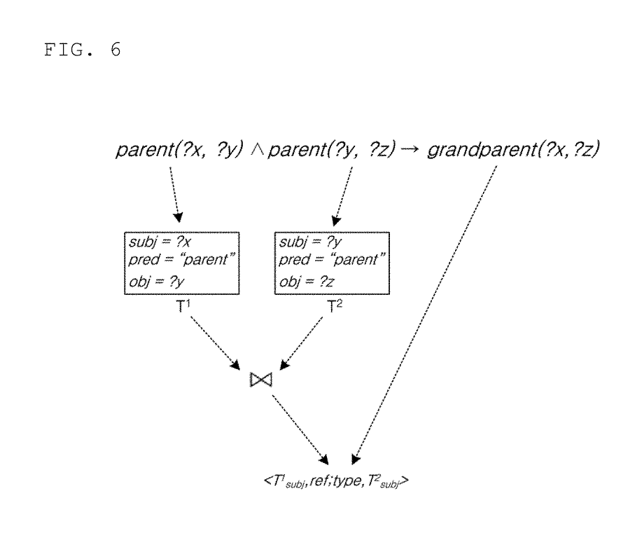

FIG. 6 is a diagram illustrating another example of parsing of the SWRL-based user-defined rules according to the exemplary embodiment of the present invention.

Referring to FIG. 6, the SWRL-based user-defined rule means “if x is a parent of y and y is a parent of z, x is a grandparent of z”. In this case, two general conditions are included in the condition section.

A general condition parent(?x, ?y) has the same meaning as (?x, parent, ?y), and a first component is ‘?x’, a second component is ‘parent’, a third component is ‘?y’ and ‘?x’ and ‘?y’ are variables. A general condition parent (?y, ?z) has the same meaning as (?y, parent, ?z), and a first component is ‘?y’, a second component is ‘parent’, a third component is ‘?z’ and ‘?y’ and ‘?z’ are variables.

In this case, since the comparison condition is not present in the condition section, the processor 212 generates condition meta information for each general condition. The two general conditions include the same number of variables, so that the condition meta information is generated sequentially.

That is, the processor 212 sequentially generates condition meta information T1 and condition meta information T2, which are the conditional meta information B. In this case, the subject information of the condition meta information T1 is ‘?x’ which is the first component of the general condition parent(?x, ?y), the predicate information of the condition meta information T1 is ‘parent’ which is the second component of the general condition parent(?x, ?y), and the object information of the condition meta information T1 is ‘?y’ which is the third component of the general condition parent(?x, ?y). In addition, the subject information of the condition meta information T2 is ‘?x’ which is the first component of the general condition parent(?y, ?z), the predicate information of the condition meta information T2 is ‘parent’ which is the second component of the general condition parent(?y, ?z), and the object information of the condition meta information T2 is ‘?z’ which is the third component of the general condition parent(?y,?z).

Thereafter, the processor 212 generates result meta information corresponding to the result. That is, the processor 212 sets the first component ‘?x’ of the result as the subject information of the result meta information, sets the second component ‘grandparent’ of the result as the predicate information of the result meta information, and sets the third component ‘?z’ of the result as the object information of the result meta information.

Referring back to FIG. 4, in step 420, the processor 212 retrieves a plurality of triple data from two or more triple data stored in the memory 211 using a plurality of condition meta information. At this time, the processor 212 may retrieve the corresponding triple data based on variable information (i.e., the first component or the third component) included in the condition meta information.

Based on an example described in FIG. 5, it is assumed that triple data (Tom, hasGender, male), (Bob, hasGender, male), (Alice, hasGender, female), (Tom, hasAge, 28), (Bob, hasAge, 16), and (Alice, hasAge, 17) are stored in the memory 211. At this time, the triple data (Tom, hasGender, male) and (Bob, hasGender, male) are retrieved based on variable information (that is, the subject information ‘?x’) included in the condition meta information T1. Also, based on the variable information (that is, the subject information ‘?x’ and the object information ‘<20’) included in the condition meta information T2, the triple data (Bob, hasAge, 16) and (Alice, hasAge, 17) are retrieved.

Thereafter, in step 430, the processor 212 generates or reasons new triple data from the plurality of retrieved triple data using the result meta information. The reasoned new triple data is stored in the memory 211.

Based on an example described in FIG. 5, the processor 212 retrieves triple data having the same subject by analyzing the triple data retrieved through the condition meta information T1 and the triple data retrieved through the condition meta information T2. Accordingly, the triple data (Bob, hasGender, male) and (Bob, hasAge, 16) are retrieved, and the two triple data retrieved are joined.

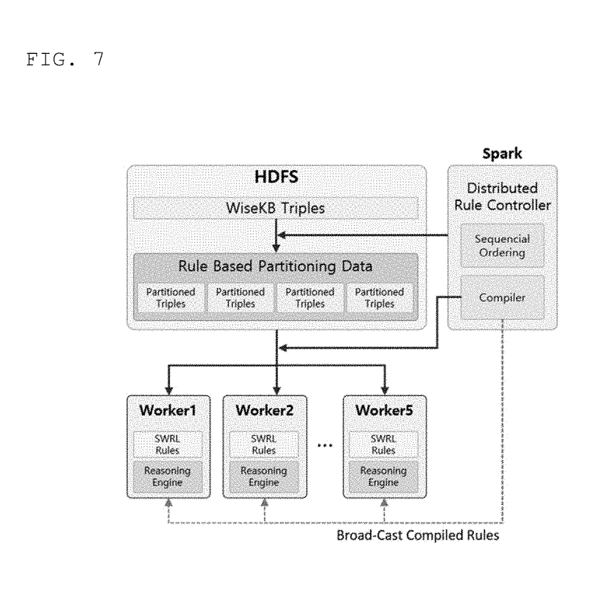

Thereafter, the processor 212 reasons new triple (Bob, ref:type, boy) using the two joined triple data and the result meta information and the reasoned triple data (Bob, ref:type, boy) is stored in the memory. Accordingly, new information about Bob is added as illustrated in FIG. 7.

Meanwhile, the new triple data generated by one ontology-based reasoning apparatus 210 may be transmitted (broadcasted) to other ontology-based reasoning apparatus 210 included in the ontology-based reasoning system 200, and each of other ontology-based reasoning apparatus 210 stores the new triple data received in the memory 211 and may use the new triple data stored during another reasoning later.

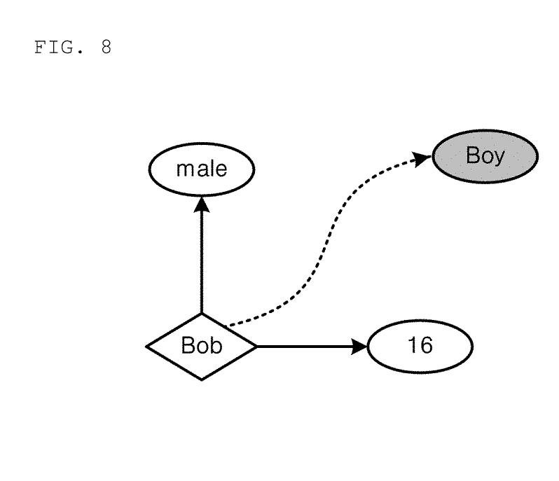

FIG. 8 illustrates a concept for distributed reasoning.

Referring to FIG. 8, each node constituting a cluster in a distributed environment, that is, the ontology-based reasoning apparatus 210 stores the triple data required for a specific rule in a partition form, and the reasonable triple data is stored in one node and the reasoning rules that have been analyzed above are broadcasted and loaded into the memory of each node. Accordingly, in the actual reasoning step, it is reasoned that the triple data corresponding to the condition section is found for each rule and the actual new data is generated through the result. Therefore, in the case of the present invention, network shuffling may be reduced.

In addition, in order to reduce the retrieving time of the triple data performed in step 420, two or more triple data may be classified based on the predicate and stored in the memory 211.

That is, according to the exemplary embodiment of the present invention, the memory 211 may store two or more triple data in a form of table A. In this case, a column of the table A may be a predicate of two or more triple data, a row of the table A may be a subject of two or more triple data, and a value of the table A may be an object of two or more triple data or a null value.

In this case, the processor 212 may retrieve a plurality of triple data corresponding to a plurality of condition meta information based on the predicates of two or more triple data.

For example, when five triple data SPO stored in the memory 211 are (Lee,graduatedFrom, seoul_Univ), (Park, wasBornOn, Seoul), (Park, spouse, Kim), (Choi, graduatedFrom, soongsil_Univ), and (Choi, spouse, soongsil_Univ), the table A shown in Table 2 below may be generated.

TABLE 2

| ID | graduatedFrom | wasBornOn | spouse |
|---|---|---|---|
| Lee | seoul_Univ | null | null |
| Park | null | Seoul | kim |
| Choi | soongsil_Univ | null | Yoon |

In other words, the table A is a table setting predicates of two or more triple data as columns, and there is an advantage in that locality is ensured because a probability that the triple data having the same predicate are to be stored in the same node is high. Therefore, in the case of querying data based on the predicates, it is possible to guarantee a fast response speed to be described below because a probability to exist in the same node is high and the network shuffle in which the data moves between the nodes may be prevented as much as possible.

Meanwhile, according to the exemplary embodiment of the present invention, when the new triple data is reasoned as the result, the processor 212 may perform incremental reasoning that reasons the result by setting the new triple data and at least one triple data among two or more triple data as conditions.

More specifically, the incremental reasoning means repeated reasoning until new date is no longer reasoned using existing triple data and added triple data when new triple data is reasoned or new triple data is added after reasoning.

In this case, the processor 212 may perform incremental reasoning based on a table B illustrating two or more ontology-based rules and a relationship between the two or more ontology-based rules. At this time, the result of any one ontology-based rule of two or more ontology-based rules is set as a condition of another ontology-based rule of two or more ontology-based rules. In addition, the table B includes two columns, and in each row included in a column A of the two columns, each of the two or more ontology-based rules is set as a value, and in each row included a column B of the two columns, each of the ontology-based rules affected by the value of the column A may be set as a value.

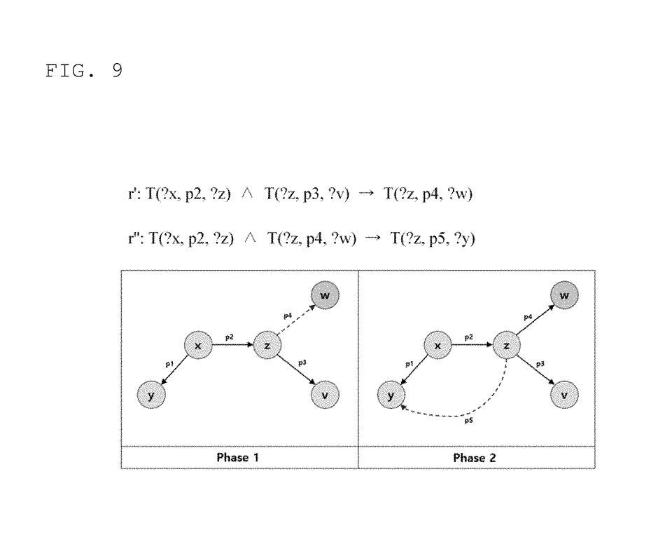

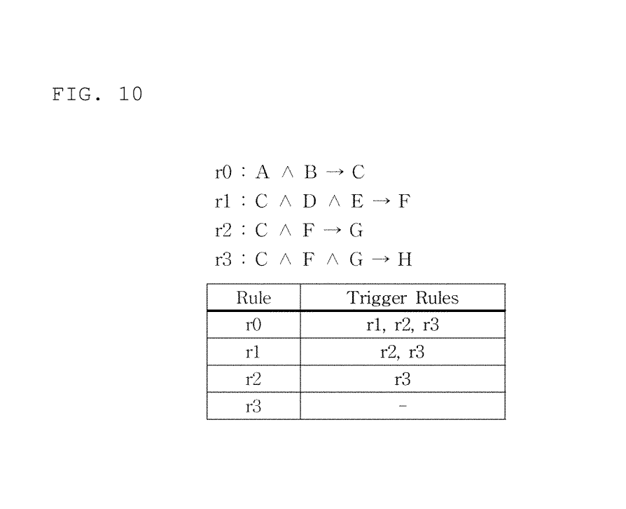

Hereinafter, the concept of incremental reasoning will be described in more detail with reference to FIGS. 9 and 10.

Referring to FIG. 9, rules r′ and r″ are examples of the SWRL-based reasoning rules described above. A format of the triple data of the conclusion section corresponding to the reasoning result of r′ is the same as the triple data format of the second condition of r″. Thus, the reasoning rule of r′ affects the reasoning rule of r″, and r″ is dependent on the reasoning result of r′. Therefore, in phase1, the p4 relation between z and w is reasoned, and in phase2, z and y having the p5 relation which can not be reasoned in phase1 may be reasoned through the p4 relation reasoned from the previous step.

Further, referring to FIG. 10, reasoning results of rules r0, r1, r2, and r3 are used in the condition section of each rule, and the rules affecting the rules are expressed through the table B, thereby improving reasoning performance by selecting rules required for performing the next step in the incremental reasoning. In this case, the table B includes two columns, ‘Rule’ and ‘TriggerRule’, and four rules are set as a value in ‘Rule’ and each ontology-based rule affected by the value of ‘Rule’ may be set as the value in ‘Trigger Rule’.

For example, according to the present invention, it is possible to minimize network shuffling occurring in distributed reasoning processing and reduce a required time for reasoning by performing reasoning using the user-defined rules.

Further, the exemplary embodiments of the present invention are implemented in a form of program commands which may be performed through various computer means and may be recorded in a computer readable medium. The computer readable medium may include one or a combination of a program command, a data file, a data structure, and the like. The program command recorded in the medium may be specially designed and configured for the present invention, or may be publicly known to and used by those skilled in the computer software field. Examples of the computer readable recording medium include a magnetic media, such as a hard disk, a floppy disk, and a magnetic tape, an optical media, such as a CD-ROM and a DVD, a magneto-optical media, such as a floptical disk, a ROM, a RAM, and a flash memory. Examples of program commands include high-level language codes that can be executed by a computer using an interpreter or the like as well as machine language codes such as those generated by a compiler. The hardware devices may be configured to operate as one or more software modules in order to perform the operations of the exemplary embodiments of the present invention, and an opposite situation thereof is available.

As described above, the present invention has been described by the specified matters such as specific components and the limited exemplary embodiments and drawings, which are just provided to help the overall understanding of the present invention, and the present invention is not limited to the exemplary embodiments, and those skilled in the art will appreciate that various modifications and changes can be made from the disclosure. Therefore, the spirit of the present invention is limited to the exemplary embodiments described above, and it should be appreciated that all equal or equivalent modifications as well as the appended claims to be described below belong to the spirit of the present invention.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An ontology-based reasoning apparatus, comprising:
a memory storing two or more triple data; and
a processor connected to the memory,
wherein the processor parses user-defined rules input from a user in ontology-based rules to generate a plurality of condition meta information corresponding to a plurality of conditions included in a condition section of the user-defined rules and one result meta information corresponding to one result included in a conclusion section of the user-defined rules, retrieves a plurality of triple data in two or more triple data prestored using the plurality of condition meta information, and reasons new triple data from the plurality of triple data retrieved using the result meta information to store the reasoned new triple data in the memory.

2. The ontology-based reasoning apparatus of claim 1, wherein the condition is one of a general condition and a comparison condition, the general condition and the comparison condition include at least one variable, the comparison condition includes a comparison function for limitation of the variable, and the condition meta information includes subject (S) information, predicate (P) information, and object (O) information.

3. The ontology-based reasoning apparatus of claim 2, wherein each of the general condition and the comparison condition includes a first component, a second component, and a third component,
the first component of the general condition corresponds to the subject information of the condition meta information, the second component of the general condition corresponds to the predicate information of the condition meta information, and the third component of the general condition corresponds to the object information of the condition meta information,
the first component of the comparison condition corresponds to the subject information of the result meta information, the second component of the comparison condition corresponds to a comparison function, and the third component of the comparison condition corresponds to a limited value of the first component of the comparison condition, and
at least one of the first component and the third component of the general condition constitutes a variable and the first component of the comparison condition constitutes a variable.

4. The ontology-based reasoning apparatus of claim 3, wherein when the conditional section includes both the general condition and the comparison condition, the processor retrieves a general condition including the same variable as one variable included in the comparison condition among the general conditions included in the condition section and generates one condition meta information A by merging the comparison condition and the retrieved general condition.

5. The ontology-based reasoning apparatus of claim 4, wherein the subject information of the condition meta information A is a first component of the retrieved general condition, the predicate information of the condition meta information A is a second component of the retrieved general condition, and the object information of the condition meta information A is a value that limits the third component of the comparison condition to the second component of the comparison condition.

6. The ontology-based reasoning apparatus of claim 3, wherein the processor generates one condition meta information B from one general condition which is not merged with the comparison condition, and subject information of the condition meta information B is the first component of the general condition, predicate information of the condition meta information B is the second component of the general condition, and object information of the condition meta information B is the third component of the general condition.

7. The ontology-based reasoning apparatus of claim 3, wherein the result meta information includes subject information, predicate information, and object information, the result includes a first component, a second component, and a third component, and the subject information of the result meta information is the first component of the result, the predicate information of the result meta information is the second component of the result, and the object information of the result meta information is the third component of the result.

8. The ontology-based reasoning apparatus of claim 1, wherein the memory stores the two or more triple data in a form of table A, a column of the table A is a predicate of the two or more triple data, a row of the table A is a subject of the two or more triple data, and a value of the table A is an object of the two or more triple data or a null value, and the processor retrieves the plurality of triple data corresponding to the plurality of condition meta information based on the predicates of the two or more triple data.

9. The ontology-based reasoning apparatus of claim 1, wherein the processor performs incremental reasoning that reasons the result by setting the new triple data and at least one of the two or more triple data as conditions when the new triple data is reasoned as a result.

10. The ontology-based reasoning apparatus of claim 9, wherein the processor performs the incremental reasoning based on a table B that indicates two or more ontology-based rules and a relationship between the two or more ontology-based rules, the result of any one ontology-based rule of the two or more ontology-based rules is set as a condition of another ontology-based rule of the two or more ontology-based rules, the table B includes two columns, and in each row included in a column A of the two columns, each of the two or more ontology-based rules is set to a value, and in each row included in a column B of the two columns, each of the ontology-based rules affected by the value of the column A is set as a value.

11. An ontology-based reasoning system, comprising:
a plurality of ontology-based reasoning apparatuses including memories and processors,
wherein each of the plurality of ontology-based reasoning apparatuses parses user-defined rules input from a user in ontology-based rules to generate a plurality of condition meta information corresponding to a plurality of conditions included in a condition section of the user-defined rules and one result meta information corresponding to one result included in a conclusion section of the user-defined rules, retrieves a plurality of triple data in two or more triple data prestored using the plurality of condition meta information, and reasons new triple data from the plurality of triple data retrieved using the result meta information to store the reasoned new triple data in the memory,
when the reasoning of the new triple data is completed in any one ontology-based reasoning apparatus among the plurality of ontology-based reasoning apparatuses, the any one ontology-based reasoning apparatus transmits the reasoned new triple data to the remaining ontology-based reasoning apparatuses except for the any one ontology-based reasoning apparatus among the plurality of ontology-based reasoning apparatuses.

12. An ontology-based reasoning method which is performed by an apparatus including a processor, comprising:
parsing user-defined rules which are rules newly defined by a user in ontology-based rules constituted by a condition section and a conclusion section to generate a plurality of condition meta information corresponding to a plurality of conditions included in the condition section and one result meta information corresponding to one result included in the conclusion section;
retrieving a plurality of triple data in two or more triple data prestored using the plurality of condition meta information; and
reasoning new triple data from the plurality of triple data retrieved using the result meta information.
